(19) United States
(12) Patent Application Publication
(10) Pub. No.: US 2007/0047579 A1
(43) Pub. Date: Mar. 1, 2007

(54) Multipacket interface

(76) Inventors: Suvhasis Mukhopadhyay, Shrewsbury, MA (US); Santanu Bhattacharya, Delhi (IN); Vikas Kumar, New Delhi (IN); Kumar Shakti Singh, New Delhi (IN); Arunava Dutta, New Delhi (IN); Desikan Srinivasan, New Delhi (IN)

Correspondence Address: GORDON & JACOBSON, P.C., 60 LONG RIDGE ROAD, SUITE 407, STAMFORD, CT, 06902, US

(21) Appl. No.: 11/210,126

(22) Filed: Aug. 23, 2005

(51) Int. Cl. H04J 3/16

(52) U.S. Cl. 370/469; 370/437

(57) ABSTRACT

A multipacket interface is easily adaptable to any of several link layer interfaces via a simple adaptation layer which can be provided on an ASIC or FPGA. The interface according to the invention includes (in both transmit and receive directions) a multi-bit data signal, a multi-bit channel identifier, a packet abort/error signal, a start-of-frame signal, an end-of-frame signal, a data valid signal, and an interface clock. In the transmit direction, the interface also includes a data request signal and a multi-bit PDU length indicator signal. In the receive direction the interface also includes a server signal failure signal.

### BACKGROUND OF THE INVENTION

1. Field of the Invention

This invention relates broadly to telecommunications. More particularly, this invention relates to methods and apparatus for a link layer—physical layer interface.

2. State of the Art

Modern telecommunication relies on many protocols for the transport and multiplexing of data. Moreover, many different transmission media are used, e.g. copper wire, optical fiber, radio signal, etc. It is desirable that the different protocols be able to make use of different media. Telecommunication media and protocols are often conceived of as “layers”. While there is some disagreement as to how many layers there should be, most protocol suites share the concept of at least three layers: media, transport, and application. The media layer may be divided into two layers: the physical layer and the link layer. The physical layer involves the actual signaling and medium for the signals, e.g. serial data link (RS-232), 10 megabit Ethernet (10BASE-T), and the synchronous optical network (SONET), etc. The link layer involves addressing schemes such as media access control (MAC), asynchronous transfer mode (ATM), high level data link control (HDLC), fiber channel (FC), generic framing procedure (GFP), etc. Protocol layers communicate with each other via “interfaces”. Popular link layer—physical layer interfaces include Universal Test & Operations Physical Interface for ATM (UTOPIA), packet over SONET physical layer (POS-PHY), system packet interface (SPI), etc.

Link layer protocols and their associated physical layer interfaces utilize different protocol data units (PDUs). For example, ATM and the UTOPIA interface utilize the 53-byte cell. The basic SONET frame is 810 bytes. However, SONET bandwidth is adjusted using virtual concatenated groups (VCGs). Other protocols use variable length packets. Many different link layer protocols are adapted to use the SONET physical layer via the various interfaces mentioned above.

Generic Framing Procedure utilizes a variable length PDU and requires that the PDU length be indicated at the start of the PDU. When receiving data via a link layer protocol for retransmission using GFP, the data must be buffered until a full packet has been received (and the packet length thus known) before it can be retransmitted. Furthermore, when receiving data via a link layer protocol for retransmission via a SONET signal, it is often necessary to compensate for different clock domains. This requires a buffer and some kind of flow control signaling.

In constructing SONET switching devices it is desirable to provide as much functionality as possible on a single chip. However, chip real estate is limited. While it might be desirable to provide the functionality of multiple link layer protocols on a single chip, generally there is simply not enough space.

### SUMMARY OF THE INVENTION

It is therefore an object of the invention to provide a link layer—PHY layer interface which is optimal for GFP.

It is also an object of the invention to provide a link layer—PHY layer interface which minimizes the need for buffers.

It is another object of the invention to provide methods and apparatus for supporting multiple link layer protocols on a single chip.

In accord with these objects, which will be discussed in detail below, the invention provides a multipacket interface (MPI) which includes (in both transmit and receive directions) a 32-bit data path, a 5-bit channel identifier, a packet abort/error signal, a start-of-frame signal, an end-of-frame signal, a data valid signal, and an interface clock. In the transmit direction, the interface also includes a 1-bit data request signal and a 16-bit PDU length indicator. In the receive direction the interface also includes a 1-bit server signal failure signal. All of the receive side signals are outputs from the PHY layer side and inputs to the link layer side. All of the signals on the transmit side are inputs to the PHY layer device and outputs from the link layer device except for clock, channel number and data request which are outputs from the PHY layer side and inputs to the link layer device. The total number of pins needed to support the interface is 117 (55 for the receive part and 62 for the transmit part).

The interface according to the invention provides direct access to PDU Encapsulation (framing) channels and corresponding SONET VCGs to any kind of standards-based or proprietary link layer—PHY layer interface via an appropriate adaptation layer. This allows users greater flexibility in using the PDU framing channels and the SONET VCGs. If the inventive interface is implemented on both the PHY layer and the link layer, no adaptation layer is needed.

A clock adaptation buffer is not required on the PHY layer device as the interface makes use of the buffer on the adaptation layer device, or if the interface is implemented on both the PHY layer and the link layer, the adaptation buffer on the link layer device is used. Channel polling is performed on the PHY layer with the PHY layer being the timing master. The backpressure data request signal is controlled by the PHY layer.

The 5-bit channel identifier supports up to thirty-two channels (although the presently preferred embodiment uses twenty-four channels) or “ports” which are time division multiplexed over the four byte wide data path. The channel identifier is used together with the data request signal. This assures that head of line blocking on one channel does not adversely affect the other channels. The 5-bit out-of-band channel ID allows for greater bandwidth and higher speed.

The use of an out-of-band payload length indicator allows GFP framing on PDUs without having to buffer payload and add to latency. None of the existing link layer-PHY layer interfaces are capable of doing this; but the interface according to the invention allows this optimization for GFP. Therefore, in this context, the interface allows optimal operation with respect to external network processors which already buffer payload.

The interface according to the invention also allows multiple different types of PDUs (fixed and variable length) to be exchanged on different channels of the same interface. In other words, the interface allows for mapping mixed traffic into a common transport layer. The interface according to the invention is easily adaptable to any of several link layer interfaces via a simple adaptation layer which can be provided on an ASIC (application specific integrated circuit) or FPGA (field programmable gate array).

Additional objects and advantages of the invention will become apparent to those skilled in the art upon reference to the detailed description taken in conjunction with the provided figures.

### BRIEF DESCRIPTION OF THE DRAWINGS

FIG. 1 is a high level schematic diagram illustrating the different signals which comprise the multipacket interface;

FIG. 2 is a high level schematic diagram illustrating a SONET mapper incorporating the multipacket interface together with a SPI adaptation device;

FIG. 2A is a high level block diagram of an FPGA adaptation layer for SPI-3;

FIG. 2B is a high level schematic diagram illustrating a SONET mapper incorporating the multipacket interface together with a link layer device which also incorporates the multipacket interface;

FIG. 3 is a high level schematic diagram illustrating a SONET mapper incorporating the multipacket interface together with an FC adaptation device;

FIG. 4 is a high level schematic diagram illustrating a SONET mapper incorporating the multipacket interface together with a UTOPIA adaptation device;

FIGS. 5 and 6 are high level schematic diagrams illustrating a SONET mapper incorporating the multipacket interface together with other interfaces;

FIG. 7 is a timing diagram illustrating the receive part of the interface; and

FIG. 8 is a timing diagram illustrating the transmit part of the interface.

### DETAILED DESCRIPTION

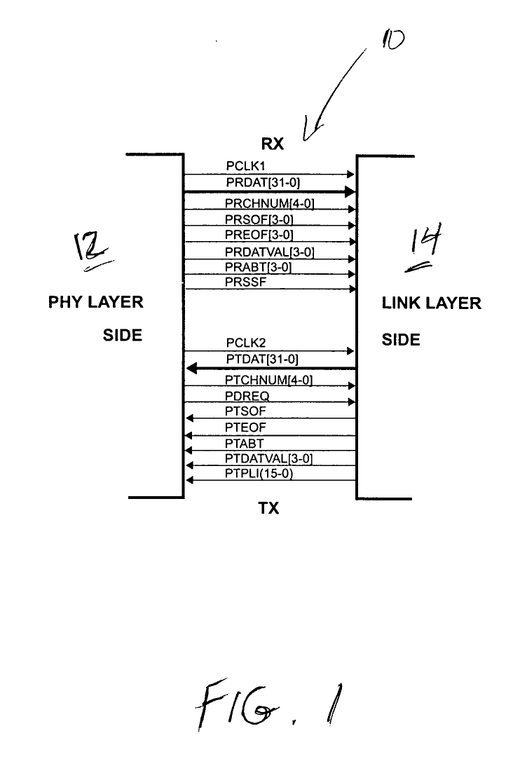

Turning now to FIG. 1, the interface 10 according to the presently preferred embodiment of the invention couples a PHY layer device 12 with a Link Layer adaptation device 14. The Link Layer adaptation device can be readily implemented in a field programmable gate array (FPGA). The PHY layer device is typically implemented as an ASIC. In the receive (RX) direction the Link Layer device receives the following signals from the PHY layer device: a clock signal PCLK1, a 32-bit data signal PRDAT, a 5-bit channel identifier signal PRCHNUM, a 4-bit start-of-frame signal PRSOF, a 4-bit end-of-frame signal PREOF, a 4-bit data valid signal PRDATVAL, a 4-bit packet abort/error signal PRABT, and a 1-bit server signal failure signal PRSSF. The reason why the PRSOF, PREOF, PRDATVAL and PRABT signals are four bits is to provide separate one-bit signals for each byte on the 32-bit data signal PRDAT.

In the transmit (TX) direction, the Link Layer device receives three signals from the PHY layer device and transmits six signals to the PHY layer device. The received signals are: a clock signal PCLK2, a 5-bit channel identifier signal PTCHNUM, and a 1-bit data request signal PDREQ. The signals transmitted to the PHY layer device are: a 32-bit data signal PTDAT, a 1-bit start-of-frame signal PTSOF, a 1-bit end-of-frame signal PTEOF, a 1-bit packet abort/error signal PTABT, a 4-bit data valid signal PTDATVAL, and a 16-bit PDU length indicator signal PTPLI.

In the presently preferred embodiment of the invention, the total number of pins needed to support the interface is 117 (55 for the receive part and 62 for the transmit part). According to the presently preferred embodiment, the clock signals PCLK1 and PCLK2 are 100 MHz clock signals which provides a total bandwidth of about 3.2 GHz (3.2 gigabits per second) which makes the interface ideally suited for handling a 2.488 GHz SONET/SDH frame.

Those skilled in the art will appreciate that a standard SPI-3 interface includes the following receive side signals: a 32-bit data signal RDAT, a clock signal RFCLK, a 1-bit receive enable signal RENB, a 2-bit valid byte config signal RMOD, a 1-bit parity signal RPRTY, a 1-bit valid data signal RVAL, a 1 bit start of packet signal RSOP, a 1-bit end of packet signal REOP, a 1-bit errored packet signal RERR, and a 1-bit start transfer signal (indicates in-band address) RSX.

It will also be appreciated that the SPI-3 interface includes the following transmit side signals: a 32-bit data signal TDAT, a clock signal TFCLK, a 1-bit transmit enable signal TENB, a 2-bit valid byte config signal TMOD, a 1-bit parity signal TPRTY, a 1-bit start of packet signal TSOP, a 1-bit end of packet signal TEOP, a 1-bit errored packet signal TERR, a 1-bit start transfer signal (indicates in-band address) TSX, a 1-bit selected PHY status signal (Packet Available) STPA, a 1-bit polled PHY status signal with PHY address signal PTPA, a 5-bit direct status signal DTPA, and a 6-bit PHY selection address TADR.

Table 1 illustrates how the receive side of the multipacket interface (MPI) can be mapped into an SPI-3 and vice versa.

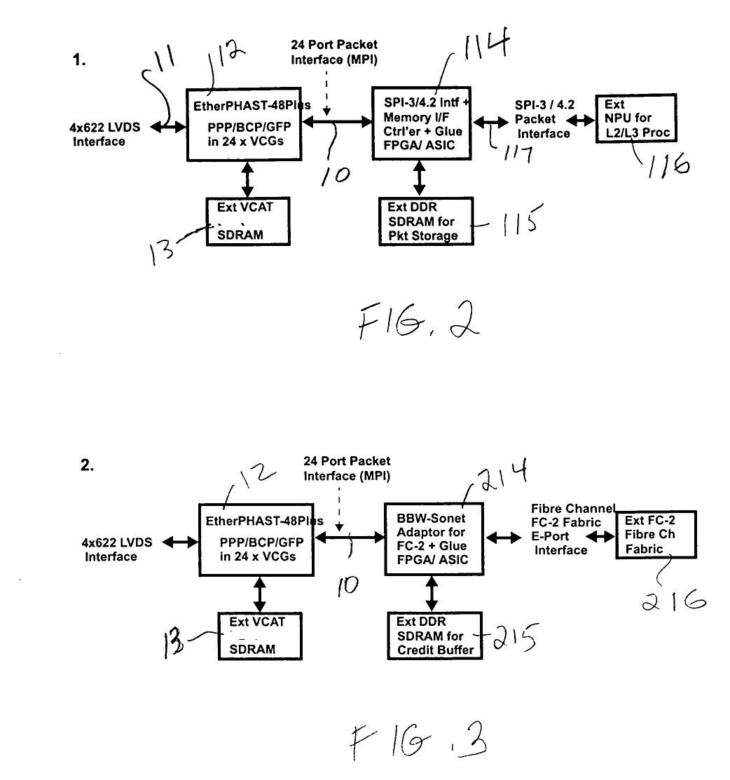

TABLE 1

| No | Rx_SPI-3 (I) | Rx_MPI (O) | MAPPING (PHY -> Link) |
|---|---|---|---|
| 1 | RDAT(31-0) | PRDAT(31-0) | SPI-3 interface data in 32 bit mode: Maps directly from the MPI |
| | | | PRDAT(31-0). PRDAT(31-0) + PRDATVALm in MPI, is converted |
| | | | directly to the SPI-3 signals RDAT(31-0) + RVAL + RMOD(1-0). |
| | | | Corresponding Start/End-of-frame signals are appropriately |
| | | | converted, as described below in relevant rows of this Table. |
| 2 | RCLK | PCLK1 | RCLK maps directly from the PCLK1 after clock adaptation |
| 3 | RSOP | PRSOF(3:0) | The SPI-3 interface does not allow two packets to share the same |
| | | | 32 bit transaction. A RSOP is always the MSB octet (Bits 31-25). |
| | | | Hence, the signal PRSOFm maps directly to RSOP. Necessary |
| | | | buffering to achieve this change in alignment is implied. |
| 4 | RENB | | In SPI-3, Flow control the PHY from Link Layer, for the general |
| | | | case. In actual scenarios, it is not possible to flow control the |
| | | | Sonet/SDH PHY. This signal not used in MPI. Hence no connection. |
| 5 | RPRTY | | Parity is not used in MPI |
| 6 | REOP | PREOF(3:0) | The particular MPI signals PREOFm, (m = 0-3), gives rise to REOP |
| | | | together RMOD(1-0) = m on SPI-3 (Example: if PREOF3, it gives |
| | | | REOP with RMOD(1-0) = (1,1). |
| 7 | RMOD(1-0) | | - See row (6) - |
| 8 | RERR | PRABT(3:0) | The particular MPI signals PRABTm + PRDATVALm + PREOFm, |
| | | | (m = 0-3) gives rise to combination RERR + REOP + RVAL + RMOD(1- |
| | | | 0) = m on SPI-3. Each of these group of signals indicate an error on |
| | | | byte ’m’. |
| 9 | RSX | | In SPI-3, when RVAL is high, indicating Valid data, RSX high |
| | | | indicates that the LSB Data byte carries the in-band address. Thus, |
| | | | RVAL + RSX(=1) + RDAT(7-0) derives from MPI signals |
| | | | PRCHNUM(N-0) and MPI PRDAT(31-0). |
| 10 | RVAL | PRDATVAL(3:0) | PRDATVALm in MPI translates to RVAL + RMOD(1-0) = m in SPI-3 |
| 11 | | PRCHNUM(N-0) | PRCHNUM(3-0) in MPI has no equivalent in SPI-3. These are |
| | | | output from the device incorporating the MPI interface, and are |
| | | | used to write in the data in the relevant interface FIFO. Whereas, |
| | | | from the SPI-3 side, the incoming in-band port address is used to |
| | | | read out the relevant inter-face FIFO. These signals are fully |
| | | | decoupled. See FIG. 2A and the description of it below. |
| 12 | | PRSSF | No equivalent in SPI-3. This signal is not used in an MPI - SPI-3 |
| | | | conversion application |

Table 2 illustrates how the interface of the transmit side of the MPI of the invention can be mapped into an SPI-3 and vice versa.

TABLE 2

| No | Tx_SPI-3 (O) | Tx_MPI (I) | MAPPING |
|---|---|---|---|
| 1 | TDAT(31-0) | PTDAT(31-0) | SPI-3 interface data in 32 bit mode: Maps directly onto the MPI |
| | | PTDATVAL(3:0) | PTDAT(31-0). PTDAT(31-0) + PTDATVALm in MPI, is converted |
| | | | directly from the SPI-3 signals TDAT(31-0) + TVAL + TMOD(1-0). |
| | | | Corresponding Start/End-of-frame signals are appropriately |
| | | | converted, as described below in relevant rows. |
| 2 | TCLK | PCLK2 | Maps directly onto the PCLK2 on the MPI (PCLK1 and PCLK2 are |
| | | | synchronous. Clock adaptation between TCLK and PCLK2 are |
| | | | provided via the interface FIFOs). See FIG. 2A and the description |
| | | | of it below. |
| 3 | TSOP | PTSOF | The SPI-3 interface does not allow two packets to share the same |
| | | | 32 bit transaction. A TSOP is always the MSB octet. For the MPI |
| | | | transmit direction also, PTSOF is always the MSB octet. Hence, |
| | | | the MPI signals PTSOF + PTDATVALm + maps directly from the SPI-3 |
| | | | TSOP. Necessary buffering to achieve this change in alignment |
| | | | is implied. |
| 4 | TENB | | In SPI-3, to indicate to the PHY TX side, to ignore Data from Link |
| | | | Layer. This signal operates independently, and there is no |
| | | | equivalent in the MPI. If there is no valid data coming in marked |
| | | | with valid indicator to the MPI, the interface will ignore these |
| | | | signals anyway. |
| 5 | TPRTY | | Parity is not used in MPI |
| 6 | TEOP | PTEOF | The particular MPI signals PTEOFm, (m = 0-3), is mapped from the |
| | | | SPI-3 TX side TEOP together TMOD(1-0) = m on SPI-3 (Example: |
| | | | if PTEOF2, it arises from TEOP with TMOD(1-0) = (1,0). |
| 7 | TADR(N-0) | | These signals in SPI-3 are used to pass FIFO Address, to do |
| | | | status polling of the interface FIFOs in the PTPA mode. The |
| | | | signals arising from the Link Layer SPI-3 interface, query the |
| | | | particular FPGA SPI-3 interface FIFOs. The FPGA SPI-3 FIFO |
| | | | being queried by the TADR(N-0) bits, returns PTPA signal high, if |
| | | | there is room in the interface FIFO to accept Data from the Link |
| | | | Layer. |
| 8 | DTPA(2_{N+1}-1:0) | | These signals in SPI-3 are hard-wired signals to indicate status of |
| | | | particular FIFOs on the PHY layer. The use of these signals is |
| | | | optional, and for this implementation of the FPGA, these are not |
| | | | relevant. |
| 9 | TMOD(1-0) | | - See row 6 - |
| 10 | TERR | PTABT | The particular MPI signals PTABTm + PTDATVALm + PTEOFm, |
| | | | (m = 0-3) arise from the SPI-3 combination |
| | | | TERR + TEOP + TVAL + TMOD(1-0) = m on SPI-3. Each of these |
| | | | group of signals indicate an error on byte ’m’. |
| 11 | TSX | | In SPI-3, when TVAL is high, indicating Valid data, TSX high |
| | | | indicates that the LSB Data byte carries the in-band address. Thus, |
| | | | TVAL + TSX(=1) + TDAT(7-0) maps into TX MPI signals |
| | | | PTCHNUM(N-0) and MPI PRDAT(31-0). |
| 12 | STPA | | Not relevant for the FPGA implementation: this is a PHY SPI-3 |
| | | | signal, used to return interface FIFO status in response to the in |
| | | | band port address received from the Link Layer SPI-3 interface. |
| 13 | PTPA | | - See row 7 - |
| 14 | | PTCHNUM(N-0) | PTCHNUM(3-0) in MPI has no equivalent in SPI-3. These are |
| | | | output from the device incorporating the MPI interface, together |
| | | | with the PDREQ signal, and are used to read out data from the |
| | | | relevant interface FIFO. If the PDREQ for a given channel number, |
| | | | for a given read cycle, is de-asserted, the read operation is |
| | | | skipped. Whereas, from the SPI-3 side, the incoming in-band port |
| | | | address is used to read out the relevant interface FIFO. These |
| | | | signals are fully decoupled. See FIG. 2A and the description of it |
| | | | below. |
| 15 | | PDREQ | Used to stop Readout of FPGA interface FIFOs. See row 14 |
| 16 | | PTPLI(15-0) | Used to convey the PDU length to the PHY TX MPI input interface. |
| | | | This is provided during packet readout from the PDU storage. This |
| | | | storage could be the NPU data memory, or the attached DDR for |
| | | | packet storage in FPGA |

FIG. 2 shows how the interface can be implemented for a SPI-3 interface. The PHY layer device 12 together with associated SDRAM 13 is coupled via the interface 10 to a SPI-3 adaptation device 114 with its associated SDRAM 115. The adaptation device 114 is coupled via a SPI-3 interface 117 to a Layer 2/Layer 3 network processing unit 116. The PHY device 12 is a SONET device which supports virtual concatenation (VCAT) and is coupled to a LVDS (low voltage differential signaling) physical layer via interface 11 which is a nibble wide OC48 interface which can also be configured as four serial OC-12 interfaces.

Those skilled in the art will appreciate that the NPU 116 includes a buffer which is used to buffer all data. If the NPU were provided with an interface according to the invention, the adaptation layer 114 and buffer 115 would not be needed. The PHY layer device 12 could directly control the buffer in the NPU using the packet length indicator PTPLI and data request PDREQ signals to effect flow control between the PHY layer device and the link layer device.

FIG. 2A illustrates the MPI-SPI-3 adaptation layer device 114 (implemented in an FPGA) in greater detail. The MPI to SPI-3 FPGA can support only the PTPA/STPA (Polled Transmit Packet Available/Selected Transmit Packet Available) operation or, if desired, can support the DTPA (Direct Transmit Packet Available) option as well. As shown in FIG. 2A, the device 114 includes an MPI interface controller 114a coupled to an address generator 114b which is coupled to interface (I/F) FIFOs 114c, and an SPI-3 interface controller 114d which is coupled to the FIFOs 114c. The device 114 also includes an MPC860 integrated microprocessor interface 114e and a DDR SDRAM interface 114f which is coupled to the address generator 114b.

The device 114 supports thirty-two ports at both the TPI interface 10 and SPI-3 interface 117 and it is compliant with the OIF SPI-3 standard for the SPI-3 interface. The TPI interface 10 operates at 100 MHz, 32-bit data, full duplex, and is a timing slave to the device 12 (FIG. 2). The SPI-3 interface 117 operates at speeds ranging from 50-125 MHz, with 32-bit wide data, full duplex. For the DTPA option, the SPI-3 interface may have an optional 8-bit wide data path operating at 100 MHz in lieu of the 32-bit data path. Optional SPI-3 Direct Status Reporting (DTPA) supports a maximum of four ports. Multiplexed status is provided for Multi-PHY operational mode.

Each PHY_Port is allocated a minimum 256 bytes of the FIFOs 114c, in both receive and transmit directions. To support a chunk size of 256 bytes, in the SPI-3 mode, it is recommended that each RX/TX Port Interface FIFO be at least 256×1.25=320 bytes. In the SPI-3 interface, programmable Chunk (burst) sizes of 64/128/256 bytes are supported. This is preferably a user configuration option for the entire interface. Only Slave (PHY) timing mode is supported for SPI-3. The interface operation is in accordance with the Single-PHY/Multi-PHY operational timing diagrams as presented in Sections 10, 10.2 and 11, 11.2 of “System Packet Level Interface Level 3 (SPI-3): OC-48 System Interface for Physical and Link Layer Devices OIF-SPI-3-01.0, June 2000”.

PTPA, DTPA, and STPA signals are deasserted during a transmit side FIFO error in the SPI-3 interface. The SPI-3 clock source is preferably selectable from either a local 100 MHz+/−50 ppm oscillator or an external variable clock source. The external variable clock source should be capable of generating a clock frequency range of 50 to 125 MHz.

The DDR SDRAM interface controller and Address generator 114b is capable of maintaining independent nonblocking queues in an external DDR SDRAM memory (not shown) for all of the thirty-two ports. The Address Controller 114b should be able to control an external memory having a minimum of 4 Mbytes.

Packets from the SPI-3 ports are mapped 1:1 to a corresponding MPI interface port. The device 114 does not terminate any un-errored user data packets, except as determined by the SPI-3 interface. The device 114 supports one standard SPI-3 interface. The signals described in Tables 1 and 2 as being supported are supported in the device 114.

Note that in the preferred embodiment of the invention DTPA support is not a requirement; hence, provisioning for the DTPA[3:0] pins is optional. Also the REOP or TEOP signals could indicate either End of Packet, or Block Available (length of block (chunk) programmable), to be able to Receive/Transmit long messages.

In the SPI-3—MPI adaptation FPGA, the SPI-3 interface is connected with a Link Layer device and the MPI is connected with a PHY Layer device in a Point to Point configuration.

The SPI-3 interface 117 is lead pin configurable to either Link (master) layer mode or PHY (slave) layer mode. However, in one embodiment of the invention, only the Slave mode is supported. Each interface (Transmit and Receive) is optionally configurable individually, hence there are two optional configuration lead pins.

Within a byte the MSB (bit 7) is the first bit to be transmitted. The Base Port address is programmable using a 3 bit offset. Individual Port addresses are unit increments from the Base Port address. The complete address range is 0 to 255. The transfer-control provides both packet-level transfer mode and byte-level transfer mode in MultiPHY mode. In Single PHY mode the transfer-control is byte-level transfer. However, if desired, only the packet-level transfer (PTPA) and byte level transfer based on selected port (STPA) need be supported.

In PHY mode, a space availability indication per channel using Polled Transmit Packet Available (PTPA) is asserted when a configurable number of bytes “nbytes1” or more, are available for storage in the Egress FIFO 114c. The de-assertion of PTPA is based on nbytes2 which indicates the number of bytes available for storage in the Egress FIFO. The values of nbytes1 and nbytes2 are programmable to 32, 64, 128, 256, 512 or 1024 bytes. Only one configuration applies for the whole interface. A space availability indication per channel using Selected Transmit Packet Available (STPA) is asserted when a configurable number of bytes “nbytes3” or more, are available for storage in the Egress FIFO 114c. The de-assertion of STPA shall be based on nbytes4 which indicates the number of bytes available for storage in the Egress FIFO. The values of nbytes3 and nbytes4 are programmable to values from 0 to 256 bytes in multiples of 8. Only one configuration applies for the whole interface.

In PHY mode and in the Receive direction (SPI-3 out) one of the channels is selected for packet transfer, based on a first available first serve, round robin algorithm. The device 114 will round robin to the next channel once the selected channel transfers an end of packet (EOP) signal or, if configured, when the selected channel transfers a programmed number of bytes. This latter case is termed Receive Burst Mode. The values of the receive burst sizes are 64, 128, 256, 512, and 1024. If configured in Receive Burst Mode, a reselection will occur when an end of packet is encountered, and the number of bytes transferred is less than the receive burst size. A block of packet data equal to the burst size is termed a chunk. Packet availability for a channel is recorded internally when either a complete packet has been stored (indicated by reception of an end of packet) or, if configured in Receive Burst mode, when a chunk of packet data equal to the burst size is stored in the channels Egress FIFO. A programmable pause of 0 or 2 cycles between transfers is implemented.

Odd, Even, or No Parity is generated and checked across the data bus. Minimum Packet size is 2 bytes. In SPI-3 Single PHY port mode, there is no port selection process using the RSX or TSX signal and the in-band address is configurable to Single PHY mode when configured in both Link/Master mode and PHY/Slave mode.

The device 114 is configurable to work in Single PHY mode and Port Aggregation mode. In Single PHY mode, the STPA signal is used in place of the DTPA signal as applicable, and defined in the standards.

The control interface 114e provides the following information to the Microprocessor block while in PHY mode: SPI-3 transmit start of packet error event and start of packet error counter (32-bits wide); SPI-3 transmit parity error event and parity error counter (32-bits wide); SPI-3 transmit packet error event and packet error counter (32-bits wide); SPI-3 transmit overflow status counter (transmit overflow condition occurs when a PHY device (12 in FIG. 2) has indicated that it cannot accept any data from the Link device by deasserting its packet available signal (DTPA) and the Link device ignores the de-asserted DTPA and continues to transmit data (Enable stays asserted)).

Packets violating the (configurable) minimum packet size at the SPI-3 interface are discarded and counted. In PHY mode the above errors are Transmit SPI-3 errors and in Link mode are Receive SPI-3 errors. In Link mode the overflow status is indicated when the RENB is de-asserted and RVAL is asserted. The same counters are used in both modes (PHY or Link).

The DDR SDRAM memory controller 114b generates addressing for each Data Port (total of 32 ports). The interface 114f clocking is synchronous to the MPI interface 10. The SPI-3 interface FIFOs 114c are provided for both the PHY to LINK and the LINK to PHY directions; whereas, external DDR memory (not shown) is provided for only the LINK to PHY direction. This is because the PHY always pushes data to the link; and in the event that RENB signal is asserted by the Link Layer, there is data loss coming from the PHY. The interface 114f supports at least a 2×2.5 Gbps=5 Gbps combined Read/write bandwidth, plus overhead as needed. To minimize access delays, burst read/write is employed, with the minimum burst size equal to the smallest configurable Chunk size (64 bytes). There preferably is a configurable option to bypass the external memory in the LINK to PHY direction.

The DDR SDRAM interface 114f is preferably fully supported via dedicated resources for I/O, timing, and digital phase locked loops or delay locked loops.

When the SPI-3 interface operates off a different clock (50-125 MHz) with regard to the MPI interface, it is possible for the PHY interface to backpressure the Link Layer (in the Link Layer to PHY direction), via a combination of the PTPA/STPA signals asserted by the PHY, and the TENB signal asserted by the Link Layer. The PTPA and STPA signals derive from the usual Interface FIFO fill levels.

The read and writes to the memory (115 in FIG. 2) are based on the generated addresses by the on-chip Address Generator 114b, which is controlled via the CHNUM(5:0) signals from the MPI interface 10, and the In-band Port Address from the SPI-3 interface 117. Note that the polling order on the MPI interface and the SPI-3 interface may be different. On-chip interface FIFOs 114c account for this via additional capacity as needed (with the external memory bypassed).

The device 114 has three main clocking domains: the MPI interface clock domain at 100 MHz (includes 114a, 114b, 114f, and part of 114c); the SPI-3 interface clock domain at any frequency between 50-125 MHz (includes 114d and part of 114c); and a Control Interface clock domain, controlled by the microprocessor interface clock 114e.

A special case of interest in the SPI-3 interface clock domain is the 100 MHz clock, in which case, it is possible to set up the operation such that the timing reduces to a synchronized case for the whole Data Path, including the intervening interface memory/interface FIFOs. However, in general, the timing domains for the MPI interface and the SPI-3 interface are separate and distinct, with the memory and the interface FIFOs serving as the clock domain boundary.

FIG. 2B illustrates the presently preferred implementation of the MPI interface 10 where the interface is directly supported by the PHY layer device 12 and the Link layer device 116′.

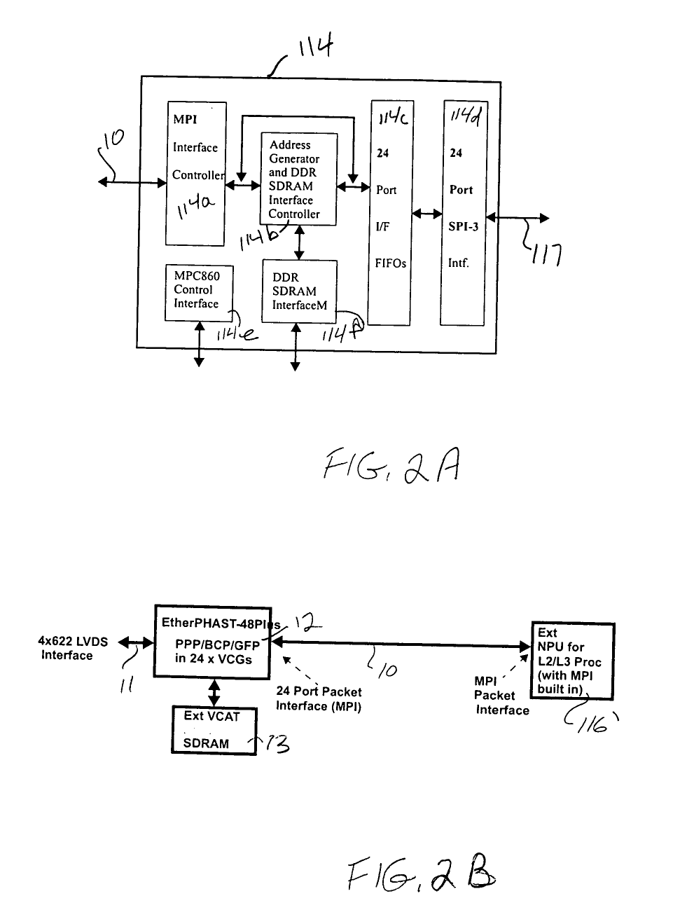

FIG. 3 illustrates how the multipacket interface 10 can be implemented for a FC-2 interface. The PHY layer device 12 together with associated SDRAM 13 is coupled via the interface 10 to a FC-2 E-port adaptation device 214 with its associated SDRAM 215. The adaptation device 214 is coupled via a FC-2 E-port interface to a FC-2 fiber channel fabric 216.

Those skilled in the art will appreciate that the Utopia-3 interface has the following receive side signals: a 32-bit data signal RDAT, a clock signal RCLK, a 1-bit receive enable signal RXENB, a 1-bit parity signal RXPRTY, a 1 bit start of cell signal RxSOC, a 4-bit cell available signal for direct reporting RXCLAV, and a 6-bit address signal for polling RXADDR.

On the transmit side, the Utopia-3 interface has the following signals: a 32-bit data signal TDAT, a clock signal TCLK, a 1-bit transmit enable signal TXENB, a 1-bit parity signal TXPRTY, a 1-bit start of cell signal TxSOC, a 4-bit cell available signal for direct reporting TxCLAV, and a 6-bit address signal for polling TXADDR.

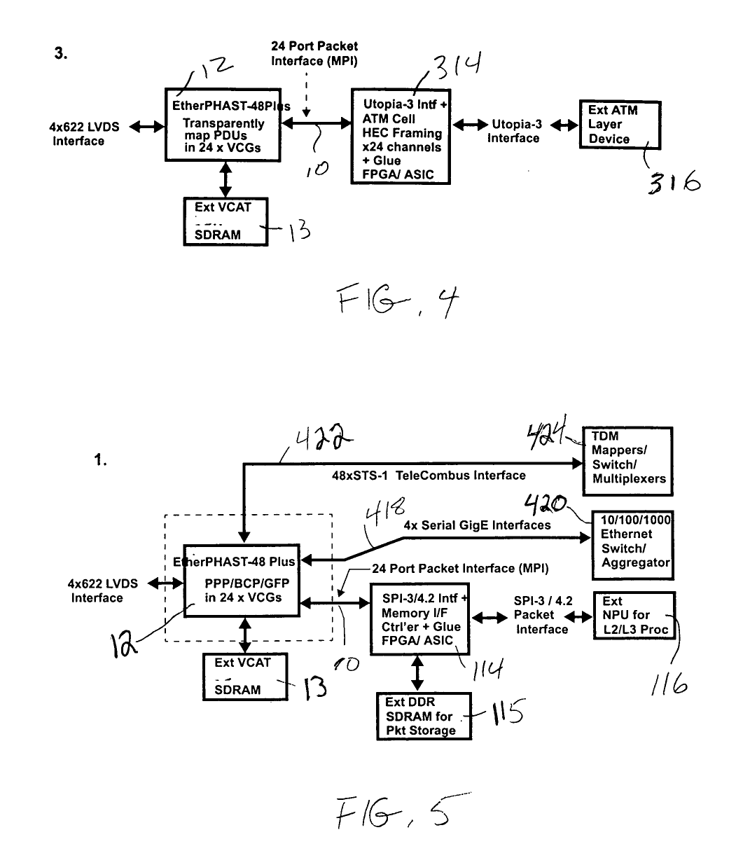

FIG. 4 shows how the interface of the invention can be used to implement a Utopia-3 interface. The PHY layer device 12 together with associated SDRAM 13 is coupled via the interface 10 to a Utopia-3 adaptation device 314. The adaptation device 314 is coupled via a Utopia-3 interface to an ATM layer device 316.

FIG. 5 is similar to FIG. 2 but illustrates an embodiment of the invention which includes two additional types of interfaces in the same device which incorporates the invention. In FIG. 5, the interface of the invention is incorporated in a SONET PHY layer device 12, having associated SDRAM 13. The interface 10 is coupled to an adaptation device 114, having associated SDRAM 115, and coupled to an L2/L3 processor 116. In addition, the PHY layer device 12 is provided with four gigabit Ethernet interfaces 418 which may be used to connect to an Ethernet switch/aggregator 420. Further, the PHY layer device is provided with a bus interface 422 which is capable of handling forty-eight STS-1 payloads as well as SONET clock, SPE, H3, and C1 signals. The bus 422 is used transfer data between the device 12 and TDM mappers/switches/multiplexers 424.

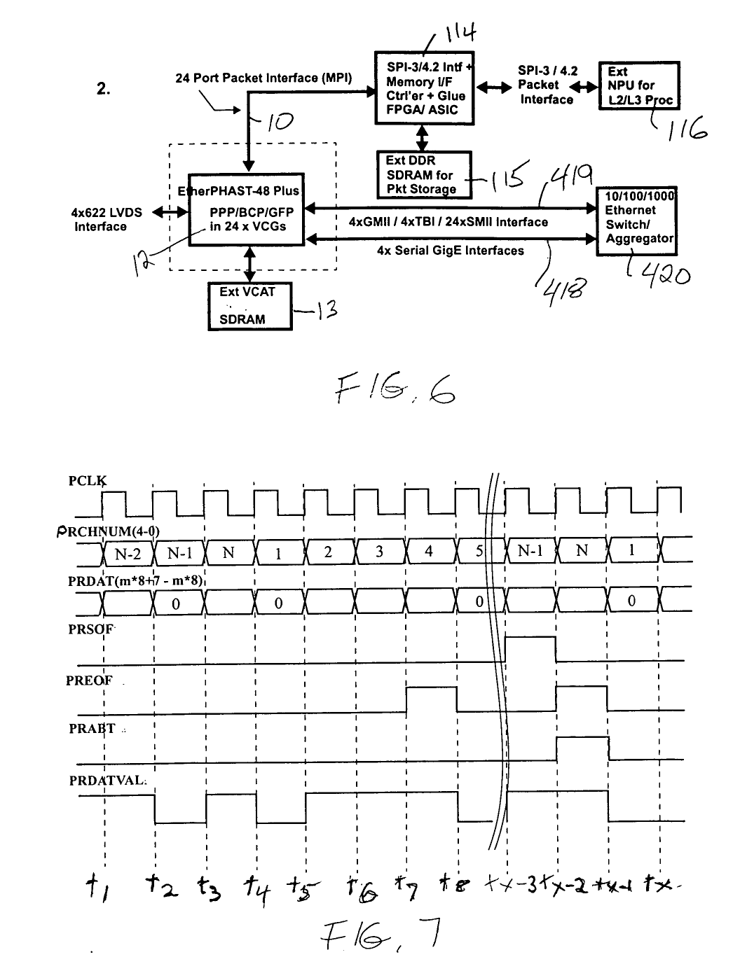

FIG. 6 is similar to FIG. 2 but illustrates an embodiment of the invention which includes four additional types of interfaces in the same device which incorporates the invention. In FIG. 6, the interface of the invention is incorporated in a SONET PHY layer device 12, having associated SDRAM 13. The interface 10 is coupled to an adaptation device 114, having associated SDRAM 115, and coupled to an L2/L3 processor 116. In addition, the PHY layer device 12 is provided with four gigabit Ethernet interfaces 418 which may be used to connect to an Ethernet switch/aggregator 420. Further, the PHY layer device is provided with a port 419 which may be configured to support four GMII (Gigabit Ethernet Media Independent Interface), four TBI (Ten Bit Interface, used for 8B/10B encoding), or twenty-four SMII (Serial Media Independent Interface, used for 100 megabit Ethernet) or a combination of these interfaces. These other interfaces may also be used to connect to certain Ethernet devices 420.

Before turning to the timing diagrams, it should be explained that the interface according to the invention may be operated in three modes: transparent mode, monitoring mode, and termination mode. These modes are with respect to the functions performed by the PHY layer device.

In the transparent mode the decapsulated traffic goes directly out to the multipacket interface 10. Only octet boundaries are guaranteed. The SOF and EOF signals mark octet boundaries. Frame delineations have to be accomplished outside the device 12 which incorporates the multipacket interface 10.

In monitoring mode the frame delineations are done internal to the device 12, but the LAPS (Link Access Protocol for SDH)/PPP (Point to Point Protocol)/BCP (Bridge Control Protocol) or GFP payload headers are not discarded, and the SOF signal lines up with the start of the payload/protocol headers. This effectively results in non-intrusive monitoring of the LAPS/GFP frame, which is passed through unterminated. The core header in case of GFP is however discarded.

In termination mode the frame delineation is done internal to the device 12, but the LAPS/PPP/BCP or GFP headers are discarded, and the SOF signal lines up with the start of the terminated, decapsulated PDU.

These modes of operation are selectable via an application programming interface (API). For purposes of the interface behavior, it is the alignment/relationship of the SOF signal that is of interest. The following notations will be used in the remaining discussion of the interface.

“n”: The number of mapping and demapping processes, or channel numbers, are referred to as “n”. The individual process can be for mapping an Ethernet frame, a packet or a block coded tributary. According to the illustrated embodiment, there are up to twenty-four channels.

“s”: The number of STS-1/VC3s (one VC-4 is treated as bandwidth capable of carrying 3 VC-3s) which can be terminated for mapping and demapping processes within the core. According to the presently preferred embodiment s has a value of 0 to 47.

“q”: The number of GFP framing adaptation processes are numbered as “q”. For a linear extension header the number “q” and “n” may be different.

“PHY”: A physical channel which is capable of carrying an Ethernet frame or PPP packets.

The receive side of the interface 10 sends m bytes over n channels from the PHY layer 12 device to the link layer device 14. Byte slots are assigned in the 32-bit data path PRDAT according to m*8+7 to m*8. In other words: Byte #3 is assigned bits 31-24, Byte #2 is assigned bits 23-16, Byte #1 is assigned bits 15-8 and Byte#0 is assigned bits 7-0. The PRDATVAL signal has m lines, one for each Byte in the 32-bit data path. PRDATVAL goes high when a valid byte is on the data path. The PRSOF signal also has m lines which go high marking the start of frame (when occurring on the m^{th} byte) for Ethernet and start of packet for PPP except for the case of transparent GFP mapping and transparent Mapping. PREOF has m lines which go high marking the End of Frame (when occurring on the m^{th} byte) for Ethernet and end of packet for PPP except for transparent GFP mapping and transparent mapping. PRABT has m lines which go high for marking a corrupt Frame/Packet received (when occurring on the mth byte) and should be aborted. These lines are active only with the respective PREOF m signal and are not active in case of GFP transparent/generic transparent mapping. PRCHNUM has 5-bits indicating which of twenty-four logical channel outputs is being sent out on the 32-bit PRDAT. PRSSF goes high when the SONET server signal fails or GFP/HDLC framing errors appear on output packet(s). PRSSF is not qualified with PRDATVALm; however, PRSSF is qualified with the PRCHNUM corresponding to the particular channel ‘n’. For reporting channel alarms, PRCHNUM have to be interpreted with the PRDATVALm (needs to be high), together with the respective PRAB™ indicating FIFO overflow (or other error conditions) which are reported as an alarm. No action based on the alarm is taken within the device 12.

The minimum packet size transferred across the interface is 2-bytes long (corresponding to consecutive SOF and EOF indications. Note the difference between the Receive and Transmit directions. In the RX direction, two PDUs need to be separated by at least a single invalid byte (since SOF alignment is not done by buffering in the RX side within the PHY layer device); therefore, separate instances of EOF/SOF and DATVAL per byte is required. Each PRSOFm assertion has a corresponding unique PREOFm′ assertion (m may or may not equal m′). In other words, a frame may start in the Byte #1 location of the data path and end in a different Byte # location.

All valid payload bytes (including errors) are passed out onto the data bus along with the applicable PRDATVALm signal asserted. PRAB™ is asserted along with the PRDATVALm and PREOFm. When an internally generated SONET/SDH trail failure signal is active, the PRDATVALm remains inactive and no data is transferred across RX part of the interface 10. During a transfer of a PDU/packet/frame across the interface, if the internally generated SONET/SDH trail failure signal is asserted, the packet being transferred is aborted, except for transparent mapping. In case of transparent mappings, the data valid signal PRDATVALm is disabled. PRSSF is asserted for transparent mapping as well as framed mapping in GFP as shown by logical equation (max[q]=max[n] for GFP Null Mode; however, max[q]<max[n] for GFP Linear Mode).

The transmit side of the interface 10 sends m bytes over n channels from the link layer device 14 to the PHY layer device 12. Byte slots are assigned in the 32-bit data path PTDAT according to m*8+7 to m*8. In other words: Byte #3 is assigned bits 31-24, Byte #2 is assigned bits 23-16, Byte #1 is assigned bits 15-8 and Byte#0 is assigned bits 7-0. The PTDATVAL signal has m lines, one for each Byte in the 32-bit data path. PTDATVAL goes high when a valid byte is on the data path. The PTSOF signal also has one line which goes high marking the start of frame for Ethernet and start of packet for PPP except for the case of transparent GFP mapping and transparent Mapping. Note that in the transmit direction, a single PTSOF is enough. This is because (1) at least one PTDATVALm has to be active for at least one byte duration in between consecutive to-be-transmitted PDUs, and (2) a frame that includes an SOF and EOF indication on two consecutive bytes corresponds to a special case of an errored or aborted frame. For this special case, an SOF or EOF indication does not appear on the interface, however, the condition is internally decoded. PTEOF is a single line which goes high for marking the end of frame for Ethernet and end of packet for PPP (except for the case of transparent GFP mapping and transparent mapping). Note that in the transmit direction a single PTEOF is enough. This is for exactly the same reason that only a single PTSOF is enough. PTABT has a single line that goes high for aborting the mapping of the current input frame and is valid only for the case of framed GFP, PPP/HDLC, transparent HDLC and LAPS X.85 mapping. The PTABT signal is aligned with the PTEOF signal and both occur on the same cycle of PCLK2. PDREQ is a single line output from the PHY layer device to the link layer device indicating data is required for the channel indicated by PTCHNUM which is a five line output from the PHY layer device to the link layer device. The delay between the PTCHNUM signal and the return data over the PTDAT/PTSOF is 7 clock cycles (PCLK2). The PTCHNUM signal leads the PDREQ signal by three clock cycles (PCLK2). Thus, the delay between the PDREQ signal and the return data over the PTDAT/PTSOF is 4 clock cycles (PCLK2). PTPLI (the sixteen bit wide incoming PDU length indicator that can indicate a length of up to a 64K-byte) lines up with the PTSOF signal. The minimum sized frame transferred across the packet Interface is at least 2-bytes long for all cases. In case of a mismatch between the states of the PTPLI bits and PTEOF, the PTPLI value overrides the PTEOF indication. For a given data request via the PDREQ, if PTDATVALm is not asserted (with the respective mth bytes) without an immediately preceding PTEOF indication, then this indicates an external FIFO underflow condition and the appropriate error management action for the input PDU of interest is implemented.

PTDAT, PTSOF, PTEOF, and PTABT are ignored when PTDATVALm is inactive. Request for data for a channel is generated ahead of time when it needs to be mapped. The packet is aborted when PTABT, PTDATVALm and PTEOF are asserted simultaneously. If the signal PTABT is asserted without PTEOF or PTDATVALm being asserted, it is ignored. When a data request is generated for a channel, and no data is provided, and no current packet/frame transmission is in progress, then an indication is provided to the mapper to insert idle/fill characters as per the configuration. This occurs inside the PHY layer device 12. When a data request is generated for a channel, and no data is provided, and a current frame is being transmitted then the frame transmission for that channel is aborted. The payload is inserted with idle/fill characters until a PTSOF is asserted for the channel upon a data request.

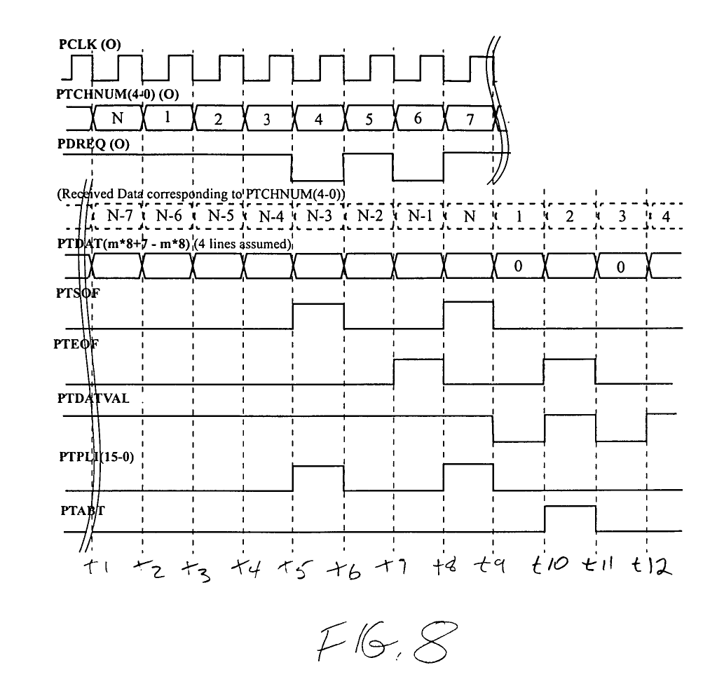

Referring now to FIG. 7, the normal functions of the RX side of the interface is shown, i.e. PRSSF is not illustrated. It should be noted from comparing the PRCLK signal to the other signals that signals change on the rising edge of the clock and are valid on the falling edge. The channel numbers RCHNUM repeat in a fixed, time division multiplexed round robin cycle. The parallel curved lines separating t8 and tx-3 show a gap in the diagram. From t1 to t2, channel N-2 is receiving data. At time t2 PRDATAVAL goes low which indicates that channel N-1 carries no valid data. At time t3, PRDATAVAL goes high and channel n receives data. At time t4, PRDATAVAL goes low and channel 1 loses data. PRDATAVAL goes high at time t5 and stays high until t8 during which time channels 2, 3, and 4 receive data. At time t7, channel 4 receives the last byte in a frame. At time t8 PRDATAVAL goes low and channel 5 loses data. At time tx-3 channel N-1 starts a new frame. At time tx-2 channel n aborts the current packet and at time tx-1 channel 1 loses data.

FIG. 8 is a timing diagram of the signals on the transmit side of the interface. In between the PDREQ signal and the PTDAT signal there are two phantom lines between which channel numbers indicate the channel for which data is actually being sent over the data path. It will be recalled that there is a seven cycle delay between PTCHNUM and PTDAT and a four cycle delay between PDREQ and PTDAT. Thus at time t1 PTCHNUM is indicating channel n but PTDAT is transmitting to channel N-7. Data for channel N is actually received at time t8. Times t2, t3, and t4 show the same delay between PTCHNUM and PTDAT. At t5, PDREQ goes low and the effect of this on PTDAT (an unused data slot indicated by 0) is seen at time t9. Similarly, when PDREQ goes low at time t7, the effect of this on PTDAT is seen at time t11.

From the foregoing, it will be appreciated that the multipacket interface provides direct access to PDU Encapsulation (framing) channels and corresponding SONET VCGs are made available to any kind of Standards based/Proprietary LINK Layer—PHY layer interface via an appropriate Adaptation Layer, that allows users greater flexibility in using the PDU Framing channels and the SONET VCGs. The MPI also allows GFP Framing on PDUs without having to buffer payload, thereby adding to latency. The multipacket interface allows optimal operation with respect to external Network Processors which already buffer payload. The interface is designed for adaptation to SONET/SDH, and allows robust framing for any generic PDU, of arbitrary length, with a fully deterministic adaptation overhead. It also allows the interface to be used by multiple types of PDUs on different channels on the same interface simultaneously. This facilitates Multi-service Aggregation applications, admitting mixed traffic for mapping into a common transport layer. An example of such a mixed application could be simultaneous mapping of ATM and Packet traffic requiring completely different and incompatible standard based physical interfaces—such as UTOPIA-2 and SPI-3.

There have been described and illustrated herein several embodiments of a multipacket interface. While particular embodiments of the invention have been described, it is not intended that the invention be limited thereto, as it is intended that the invention be as broad in scope as the art will allow and that the specification be read likewise. Thus, while a particular clock speed and data path width have been disclosed, it will be appreciated that other speeds and widths could be used. Also the five bit channel identifier is presently preferred but could be a different number of bits in a different embodiment having more or fewer channels. In addition, while the adaptation devices have been described as ASICs or FPGAs, it will be understood that a general purpose processor could be used. Also, additional pins could be provided in one or both directions to support other features such as parity for example. It will therefore be appreciated by those skilled in the art that yet other modifications could be made to the provided invention without deviating from its spirit and scope as claimed.

What is claimed is:

1. A multipacket interface for communicating between a PHY layer device and a link layer device, comprising:
a multichannel multibit data signal over which packet data from a plurality of channels is transported;
a clock signal associated with said multichannel multibit data path;
a channel number signal indicating which channel is permitted to use the data path; and
an out-of-band payload length indicator signal indicating a length of a packet being transported over said multichannel multibit data path.

2. The interface according to claim 1, wherein:
said multichannel multibit data signal is a multichannel multibyte data signal.

3. The interface according to claim 2, further comprising:
a multibit receive side start of frame signal;
a multibit receive side end of frame signal; and
a multibit receive side data valid signal.

4. The interface according to claim 3, further comprising:
a multibit receive side abort signal.

5. The interface according to claim 4, further comprising:
a receive side server signal failure signal.

6. The interface according to claim 2, further comprising:
a multibit transmit side data valid signal.

7. A multipacket interface, comprising:
a multichannel multibit receive side data signal over which packet data from a plurality of channels is transported;
a multichannel multibit transmit side data signal over which packet data from a plurality of channels is transported;
a receive side clock signal associated with said multichannel multibit receive side data signal;
a transmit side clock signal associated with said multichannel multibit transmit side data signal; and
an out-of-band payload length indicator signal indicating a length of a packet being transported via said multichannel multibit transmit side data signal.

8. The interface according to claim 7, wherein:
said data signals are both multibyte wide data signals.

9. The interface according to claim 8, further comprising:
a multibit receive side start of frame signal indicating a start of a packet from a channel transported over said multichannel multibit receive side data signal;
a multibit receive side end of frame signal indicating an end of a packet from a channel transported over said multichannel multibit receive side data signal;
a multibit receive side data valid signal indicating validity of data transported over said multichannel multibit receive side data signal; and
a multibit receive side abort signal indicating that the transported of a packet over said multichannel multibit receive side data signal is to be aborted.

10. The interface according to claim 9, further comprising:
a multibit transmit side data valid signal indicating validity of data transported over said multichannel multibit transmit side data signal.

11. A multipacket interface comprising:
a multibit data signal;
a clock signal; and
a plurality of control signals, wherein
said data signal, said clock signal, and said control signals enable communication with a plurality of different link layer protocols via adaptation layer mechanisms.

12. The interface according to claim 11, wherein:
said plurality of control signals includes an out of band payload length indicator indicating a length of a packet being transported over said multibit data signal.

13. The interface according to claim 11, wherein:
said plurality of link layer protocols includes at least two of a system packet interface (SPI) protocol, a universal test & operations physical interface for ATM (UTOPIA) protocol, and a fiber channel (FC) E-port protocol.

14. The interface according to claim 11, wherein:
the interface provides direct access to PDU encapsulation channels.

15. The interface according to claim 14, wherein:
the interface provides the link layer protocols with access to SONET virtual concatenated groups.

16. The interface according to claim 11, wherein:
said interface permits generic framing procedure (GFP) to be accomplished without buffering payload.

17. The interface according to claim 11, wherein:
said plurality of control signals includes a channel selection signal which multiplexes the data signal so that it can be used by different data sources at different times.

18. The interface according to claim 11, wherein:
said channels are used by different link layer protocols.

19. The interface according to claim 11 wherein:
the data signal is 32-bits wide.

20. The interface according to claim 11, wherein:
said control signals include start of frame, end of frame, data valid, abort, and server signal failure.

21. A PHY layer device for coupling a link layer device to a physical layer, said PHY layer device comprising:
a SONET/SDH interface; and
a PHY layer—link layer interface which includes a multichannel multibit data signal over which packet data from a plurality of channels is transported;
a clock signal associated with said multichannel multibit data signal;
a channel number signal indicating which channel is permitted use the data signal; and
an out-of-band payload length indicator signal indicating a length of a packet being transported over said multichannel multibit data signal.

22. A method for coupling a link layer device to a physical layer, comprising:
coupling a PHY layer device to the physical layer,
coupling the link layer device to the PHY layer device via a multipacket interface which includes
a multichannel multibit data signal over which packet data from a plurality of channels is transported;
a clock signal associated with said multichannel multibit data path;
a channel number signal indicating which channel is permitted to use the data path; and
an out-of-band payload length indicator signal indicating a length of a packet being transported over said multichannel multibit data path.

23. The method according to claim 22, wherein:
the multichannel multibit data signal is a multichannel multibyte data signal.

24. The method according to claim 23, wherein the multipacket interface further comprises:
a multibit receive side start of frame signal;
a multibit receive side end of frame signal; and
a multibit receive side data valid signal.

25. The method according to claim 24, wherein the multipacket interface further comprises:
a multibit receive side abort signal.

26. The method according to claim 25, wherein the multipacket interface further comprises:
a receive side server signal failure signal.

27. The interface according to claim 23, wherein the multipacket interface further comprises:
a multibit transmit side data valid signal.
